(19) United States
(12) Patent Application Publication
(10) Pub. No.: US 2018/0162056 A1
(43) Pub. Date: Jun. 14, 2018

(54) SHAPING METHOD, SHAPING SYSTEM, AND SHAPING DEVICE

(71) Applicant: MIMAKI ENGINEERING CO., LTD., Nagano (JP)

(72) Inventors: Satoshi KANEKO, Nagano (JP); Kenji HARAYAMA, Nagano (JP); Wataru HIOKI, Nagano (JP)

(21) Appl. No.: 15/837,883

(22) Filed: Dec. 11, 2017

(30) Foreign Application Priority Data
Dec. 13, 2016 (JP) 2016-240872

(51) Int. Cl. B29C 64/393; B29C 64/112; B33Y 10/00; B33Y 30/00; B33Y 70/00

(52) U.S. Cl. CPC B29C 64/393; B29C 64/112; B33Y 70/00; B33Y 30/00; B33Y 10/00

(57) ABSTRACT

Provided is a shaping method that allows an object to be shaped in a manner better suited to a shaping device used. The shaping method is a method for shaping an object having a surface colored at least in part. The shaping method includes a data generating step of generating shaping execution data representing the object in a format adapted for the shaping device, and a shaping step of shaping the object based on the shaping execution data using the shaping device and at least a plurality of materials having different colors for shaping. The data generating step further includes: executing at least color conversion based on object data representing the object using a material profile adapted for the plurality of materials having different colors to generate the shaping execution data and using, in the color conversion executed at a respective one of positions on the surface of the object, the material profile corrected in accordance with an angle of face inclination through which a face of the object is inclined relative to a preset reference plane.

### CROSS REFERENCE TO RELATED APPLICATIONS

This application claims the priority benefit of Japanese Patent Application No. 2016-240872 filed on Dec. 13, 2016. The entirety of the above-mentioned patent application is hereby incorporated by reference herein and made a part of this specification.

### TECHNICAL FIELD

This disclosure relates to a shaping method, a shaping system, and a shaping device.

### DESCRIPTION OF THE BACKGROUND ART

There are known shaping devices (3D printers) used to manufacture objects using inkjet heads (for example, Japanese Unexamined. Patent Publication No. 2015-71282). The layer stacking method may be employed in these devices, in which inks ejected from inkjet heads are cured and stacked in layers to form an object.

### SUMMARY

Using the shaping devices to form colored objects is under consideration and being discussed. To obtain a colored object, different color inks may be used to form the object's surface. The color inks may be C (cyan), M (magenta), Y (yellow), and K (black) color inks to produce diverse colors as in two-dimensional color printing using inkjet printers.

However, conditions set to color an object in such a device may differ in various aspects from conditions set for the inkjet printers. Therefore, means to form colored objects are desirably developed that are better suited to the shaping devices. This disclosure is directed to providing a shaping method, a shaping system, and a shaping device that may address the issue.

To color an object currently formed, a colored region may be formed on an outermost part of the object that is visually recognizable from outside. Further, a light-reflective region may be formed on the inner side of the colored region to allow various colors to be expressed by the subtractive color mixture as in color printing using inkjet printers. Considering that a formed object may possibly be seen in all directions and should desirably not change in color despite some chipping or cracking on its surface, the colored region may typically have a certain thickness.

As for a three-dimensional object, faces of the object inclined through different angles may be colored, unlike a 2D image printed on a flat medium, and color hues may vary with different angles through which the object's faces are inclined (angles of inclination). Such different color hues may be a problem in an attempt to color the object in desired colors and could lead to an impression that the object is unevenly colored.

The inventors conducted various studies and experiments and finally came up with the idea of executing color conversion before an object starts to be formed using a conversion profile (device profile) prepared beforehand in accordance with coloring inks used to form the object. The inventors further discussed the use of, not just any profile, but a profile corrected in accordance with angles of inclination of faces to be colored in the object.

In a process to color an object with faces inclined through variously different angles, for example, such a corrected profile may allow the color conversion to be effectively executed in accordance with angles of inclination of the object's faces. This may avoid that color hues vary with different angles of inclination of the object's faces. The inventors, through further studies and experiments, identified technical aspects required to make their finding feasible.

This disclosure provides a shaping method for shaping an object having a surface colored at least in part. The method includes a data generating step of generating shaping execution data representing the object in a format adapted for a shaping device that carries out an operation to shape the object; and a shaping step of shaping the object based on the shaping execution data using the shaping device and at least a plurality of materials having different colors for shaping. The data generating step further includes: executing at least color conversion using a material profile adapted for the plurality of materials having different colors based on object data representing the object to generate the shaping execution data; and using, in the color conversion executed at a respective one of positions on the surface of the object, the material profile corrected in accordance with an angle of face inclination through which a face of the object is inclined relative to a preset reference plane.

In the method thus characterized, the color conversion may be executed for regions to be colored on the object's surface in accordance with different angles of inclination. This may avoid that color hues vary with different angles of inclination of the object's faces. Further, the colored object may be formed in a manner better suited to the shaping device used.

Examples of the materials may include inks in liquid form that are ejectable from inkjet heads. Specific examples of the inks may include ultraviolet-curable inks. Examples of the materials having different colors may include materials (for example, inks) having C, M, Y, and K colors. The shaping device may form the object by the layer stacking method.

An example of the material profile used in this method is an ICC profile, a specific example of which may be a profile for conversion of Lab values into colors that can be expressed with the plurality of materials having different colors.

For example, a plurality of the material profiles may be associated with different angles of face inclination and prepared for use in advance. To obtain these material profiles, charts may be drawn based on the plurality of materials having different colors to measure beforehand color hues on the inclined faces. For example, a plurality of charts respectively including faces inclined through different angles may be drawn to measure color hues on these charts using a device such as colorimeter. For certain levels of quality that may be required of the object, one chart may be used and inclined through different angles to measure color hues.

The angles of face inclination at different positions of the object may be subjected to an interpolating process using values in at least two material profiles. In the interpolating process may be used a value in a first one of the material profiles associated with a smaller angle of face inclination than the angle of face inclination at each position and a value in a second one of the material profiles associated with a greater angle of face inclination than the angle of face inclination at each position. In this manner, the material profiles may be corrected in accordance with the angles of face inclination at the positions.

This disclosure may further include the use of a shaping system or device configured correspondingly to the method. Such a system or device may achieve similar effects.

The technical features disclosed herein may allow a colored object to be formed in a manner better suited to any shaping device used.

### BRIEF DESCRIPTION OF THE DRAWINGS

FIGS. 1A and 1B are drawings of a shaping system 10 that carries out a shaping method according to an embodiment of this disclosure. FIG. 1A is a drawing that illustrates a structural example of the shaping system 10. FIG. 1B is a drawing that illustrates a structural example of a main structural unit in the shaping device 100.

FIGS. 2A and 2B are drawings of a head unit 102 and a shaped object 50. FIG. 2A is a drawing that illustrates a structural example of the head unit 102. FIG. 2B is a cross-sectional view that illustrates a structural example of the shaped object 50.

FIG. 3 is a drawing that illustrates processes for color conversion executed by a host PC 200.

FIGS. 4A to 4C are drawings that illustrate angles of face inclination in the shaped object 50 obtained by a shaping device 100. FIG. 4A is a drawing that illustrates angles of face inclination in the shaped object 50 shaped as illustrated in FIG. 2B. FIG. 4B is a drawing of a shaped object 50 with small differences in level on its surface. FIG. 4C is a drawing of a shaped object 50 having a curved surface at least in part.

FIG. 5 is a flow chart of a shaping operation carried out by the shaping system 10.

FIGS. 6A to 6D are drawings that illustrate device profile correction in further detail. FIGS. 6A and 6B are schematic drawings that illustrate examples of the device profile correction. FIGS. 6C and 6D are drawings of charts 400 used in color measuring (3D color measuring) to create angle-specific profiles.

### DETAILED DESCRIPTION OF EMBODIMENTS

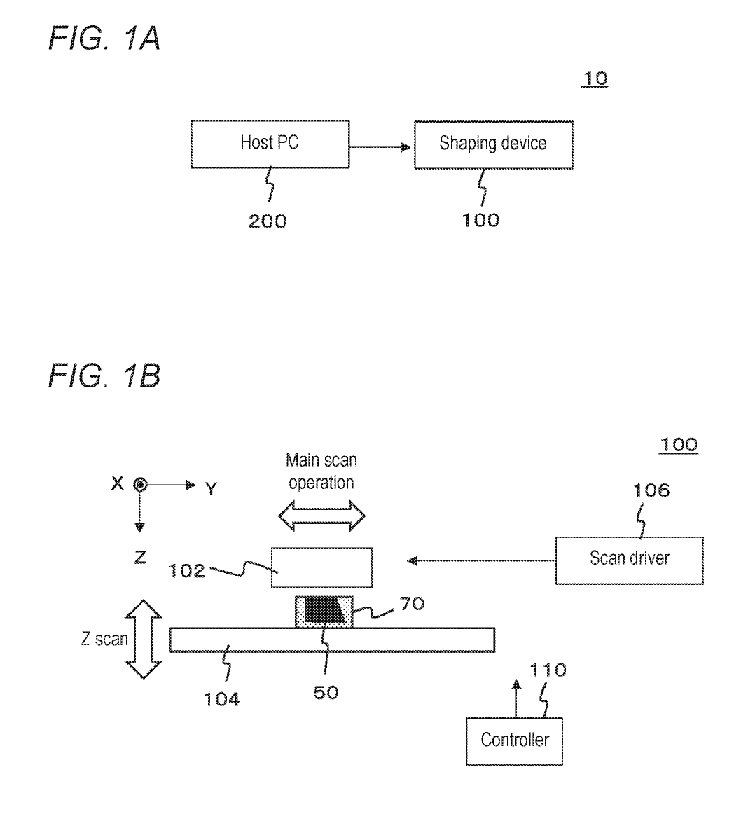

An embodiment of this disclosure is hereinafter described in detail with reference to the accompanying drawings. FIGS. 1A and 1B are drawings that illustrate a shaping system 10 that carries out a shaping method according to an embodiment of this disclosure. FIG. 1A is a drawing that illustrates a structural example of the shaping system 10.

In this embodiment, the shaping system 10 is configured to shape a three-dimensional object and includes a shaping device 100 and a host PC 200. The shaping device 100 (3D printer) carries out an operation to shape an object using the layer stacking method. The layer stacking method described herein may form an object, for example, a three-dimensional object, by stacking a plurality of layers on one another. The material used in the shaping device 100 is inks curable under certain conditions. Specific structural features of the shaping device 100 will be described later in further detail.

The host PC 200 is a computer programmed to control the operation of the shaping device 100. In this embodiment, the host PC 200 is an example of the data generating device that generates shaping execution data representing a shaped object to be formed in a format adapted for the shaping device 100. The host PC 200 generates the shaping execution data based on object data representing the shaped object in a format independent of characteristics of the shaping device 100. The host PC 200 transmits the generated shaping execution data to the shaping device 100 to prompt this device to carry out the shaping operation.

Data processes by the host PC 200 will be described later in further detail. In this embodiment, the object data is 3D model data prepared by a user. The 3D model data may be three-dimensional data representing a shaped object. The object data is, for example, standard three-dimensional data conventionally used.

Specific structural features of the shaping device 100 are hereinafter described. FIG. 1B is a drawing that illustrates a structural example of a main structural unit in the shaping device 100.

Except for structural features hereinafter described, the shaping device 100 may be similar or identical to any conventional devices for use in shaping. Specifically, the shaping device 100, except for structural features hereinafter described, may be configured similarly or identically to any conventional devices that form shaped objects, like the shaped object 50, by ejecting liquid droplets; material of the shaped object 50, from inkjet heads. In addition to the illustrated components, the shaping device 100 may include a mechanist s) and a device(s) that may be necessary to form and/or color the shaped object 50.

In this embodiment, the shaping device 100 includes a head unit 102, a shaping table 104, a scan driver 106, and a controller 110. The head unit 102 ejects liquid droplets which are the material of the shaped object 50. This head unit ejects droplets of inks curable under certain conditions and cures the inks in multiple layers constituting the shaped object 50. The ink described herein may be a material in liquid form ejectable from an inkjet head. The inkjet head may be a head from which liquid droplets (ink droplets) are ejected by the inkjet scheme. In this embodiment, the head unit 102 has a plurality of inkjet heads and ultraviolet light sources.

In this embodiment, the head unit 102 ejects from any one of the inkjet heads the material of a support layer 70. The support layer 70 described herein refers to a layered structure formed so as to surround and support the shaped object 50 currently formed. The support layer 70, if necessary, is formed during the operation to form the shaped object 50 and is removed after the operation. Specific structural features of the head unit 102 will be described later in further detail.

The shaping table 104 is a flat member that supports the shaped object 50 currently formed and is disposed at a position so as to face the inkjet heads of the head unit 102. The shaped object 50 is formed on the upper surface of this table. In this embodiment, at least the upper surface of the shaping table 104 is movable in a layer-stacking direction. When the shaping table 104 is driven by the scan driver 106, at least the upper surface of this table moves in accordance with the progress of the shaped object 50 currently formed. In this embodiment, the layer-stacking direction refers to a direction orthogonal to directions previously set in the shaping device 100 (Z direction in the drawings). The directions are specifically a main scanning direction (Y direction in the drawings) and a sub scanning direction (X direction in the drawings).

The scan driver 106 prompts the head unit 102 to perform scans in which the head unit 102 moves relative to the shaped object 50 currently formed. When the head unit 102 moves relative to the shaped object 50 currently formed, the head unit 102 may practically move relative to the shaping table 104. When the head unit 102 is prompted to perform scans, it may be the inkjet heads of the head unit 102 that practically perform the scans. In this embodiment, the scan driver 106 prompts the head unit 102 to perform main scans (Y scans), sub scans (X scans), and scans in the layer-stacking direction (Z scans).

During a main scan, the head unit 102 moving in the main scanning direction, ejects the inks. In this embodiment, the scan driver 106 prompts the head unit 102 to perform main scans by moving the head unit 102, with the shaping table 104 being secured to a position in the main scanning direction. In a modified example of the shaping device 100, the shaped object 50 may be moved by moving the shaping table 104, with the head unit 102 being secured to a position in the main scanning direction.

During a sub scan, the head unit 102 moves relative to the shaping table 104 in the sub scanning direction orthogonal to the main scanning direction. Specifically, the head unit 102, during a sub scan, moves by a preset feed rate in the sub scanning direction relative to the shaping table 104. In this embodiment, the scan driver 106 prompts the head unit 102 to perform a sub scan at an interval between main scans. The scan driver 106 prompts the head unit 102 to perform sub scans by moving the shaping table 104, with the head unit 102 being secured to a position in the sub scanning direction. The scan driver 106 may prompt the head unit 102 to perform sub scans by moving the head unit 102, with the shaping table 104 being secured to a position in the sub scanning direction.

During a scan in the layer-stacking direction, at least one of the head unit 102 and the shaping table 104 may be moved in the layer-stacking direction to cause relative movement of the head unit 102 to the shaped object 50 in the layer-stacking direction. When the head unit 102 is prompted to move in the layer-stacking direction, it may be at least the inkjet heads of the head unit 102 that move in the layer-stacking direction. When the shaping table 104 is prompted to move in the layer-stacking direction, it may be at least the upper surface of the shaping table 104 that moves in the layer-stacking direction.

The scan driver 106 prompts the head unit 102 to perform scans in the layer-stacking direction in harmony with the ongoing operation to adjust relative positions of the inkjet heads to the shaped object 50 currently formed. In this embodiment, the scan driver 106 moves the shaping table 104, with the head unit 102 being secured to a position in the layer-stacking direction. Instead, the scan driver 106 may move the head unit 102, with the shaping table 104 being secured to a position in the layer-stacking direction.

The controller 110 may be the CPU of the shaping device 100. The controller 110 controls the operation of the shaping device 100 by controlling the components of this device. In this embodiment, the shaping device 100 receives the shaping execution data from the host PC 200, and forms the shaped object 50 using the received data. Thus, the shaping device 100 may form a suitably shaped object 50.

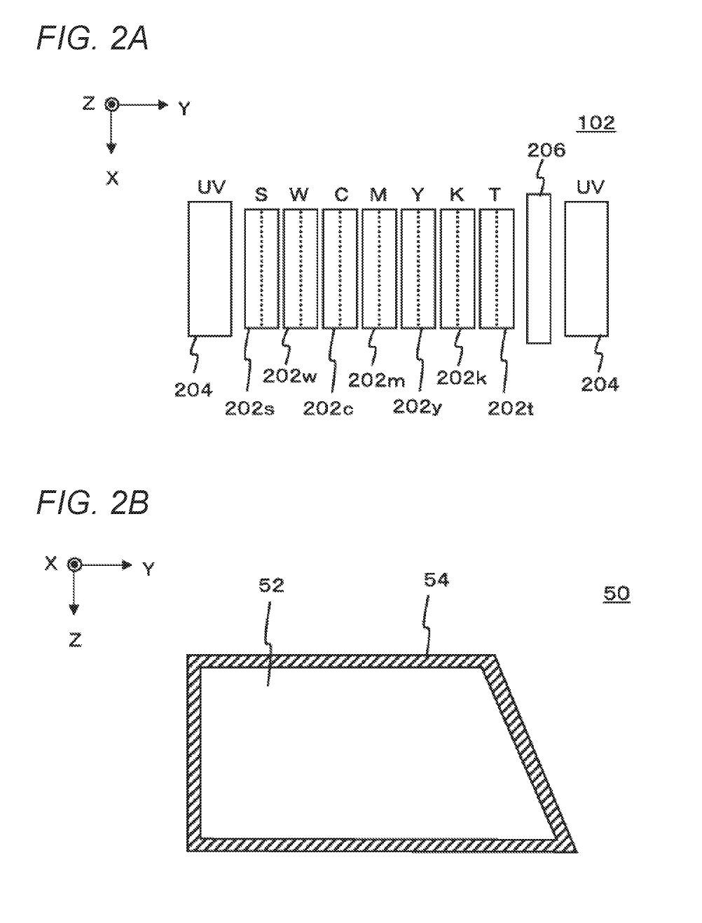

Specific features of the head unit 102 and the shaped object 50 formed in this embodiment are hereinafter described in further detail. FIGS. 2A and 2B are drawings that illustrate structural examples of the head unit 102 and the shaped object 50. FIG. 2A is a drawing that illustrates a structural example of the head unit 102.

In this embodiment, the head unit 102 includes a plurality of inkjet heads 202s, 202w, 202c, 202m, 202y, 202k, and 202t (hereinafter, inkjet heads 202s-t), a plurality of ultraviolet light sources 204, and a flattening roller 206. From the inkjet heads liquid droplets (ink droplets) are ejected by the inkjet scheme. In this embodiment, the inkjet heads 202s-t eject droplets of ultraviolet-curable inks. The inkjet heads 202s-t are arranged in the main scanning direction (Y direction) in positional alignment with one another in the sub scanning direction (X direction). The ultraviolet-curable ink may be an ink curable by being irradiated with ultraviolet light. The inkjet heads 202s-t may be any suitable ones selected from the known inkjet heads. These inkjet heads may each have, on its surface facing the shaping table 104, an array of nozzles aligned in the sub scanning direction.

The inkjet head 202s ejects ink droplets including the material of the support layer. The material of the support layer may be any suitable one selected from the known materials used to such a support layer. The inkjet head 202w ejects droplets of a white (W) ink. The white ink is used to form a light-reflective region of the shaped object 50. In this embodiment, the white ink may also be used as a modeling ink to form the interior of the shaped object 50.

The inkjet heads 202c, 202m, 202y, and 202k (hereinafter, inkjet heads 202c-k) respectively eject droplets of coloring inks having chromatic colors. In this embodiment, the inkjet heads 202c-k eject droplets of ultraviolet-curable inks having cyan (C), magenta (M), yellow (Y), and black (K) colors. These color inks are examples of inks having process colors. The inkjet head 202t ejects droplets of a transparent, clear ink.

The ultraviolet light sources 204 are ink curing devices that radiate ultraviolet light to cure ultraviolet-curable inks. The ultraviolet light sources 204 may be UVLEDs (ultraviolet LEDs). Other examples of the ultraviolet light source 204 may include metal halide lamp and mercury lamp. In this embodiment, the ultraviolet light sources 204 are disposed on one end side and the other end side of the head unit 102 in the main scanning direction, and the inkjet heads (202s-t) are interposed between these ultraviolet light sources.

The flattening roller 206 is used to flatten layers of the inks that are formed during the operation to form the shaped object 50. In this embodiment, the flattening roller 206 is disposed between one of the ultraviolet light sources 204 and the group of inkjet heads. The flattening roller 206 is used to flatten the ink layers formed by the layer stacking method to accurately adjust the thickness of each ink layer. This may ensure high accuracy in the operation using the layer stacking method.

The described structure of the head unit 102 is a non-limiting example. The head unit 102 may be structured otherwise. The arrangement of the inkjet heads 202s-t illustrated in the drawing is a non-limiting example. These inkjet heads may be arranged otherwise. Some of the inkjet heads may be displaced in the sub scanning direction from the other inkjet heads. The head unit 102 may further include an inkjet head(s) for an additional color(s). The head unit 102 may further include an inkjet head(s) 202 that ejects a coloring inks(s) having any color but the C, M, Y, and K colors. The head unit 102 may further include inkjet heads that ejects special color inks other than the process color inks. The head unit 102 may further include an inkjet head(s) that ejects an ink(s) for shaping having a predetermined color (modeling material (MO)).

FIG. 2B is a cross-sectional view that illustrates a structural example of the shaped object 50 formed in this embodiment. This is a schematic drawing of the shaped object 50 in cross section along a plane perpendicular to the sub scanning direction (X direction). In this drawing, regions constituting the shaped object 50 are identical or similar to regions in cross section along a plane perpendicular to the main scanning direction (Y direction) and the layer-stacking direction (Z direction).

As illustrated in the drawing, the shaped object 50 has an inner region 52 and a colored region 54. The inner region 52 is an inner region (modeling layer) of the shaped object 50 that forms the shape of this object. In this embodiment, the white (W) ink is used to form the inner region 52. The inner region 52 formed inside of the shaped object 50 also serves as a light-reflective region.

The colored region 54 is a region colored with the coloring inks (surface color layer). In this embodiment, the colored region 54 is in the form of a layer along the shape of the shaped object 50 that surrounds the inner region 52. The coloring inks having different colors and the clear ink are used to form this region. The coloring inks having different colors are an example of the plurality of materials having different colors.

As described earlier, the coloring inks used in this embodiment are the inks of C, M, Y, and K colors. Variously different colors may be expressed by adjusting quantities of the coloring inks to be ejected at positions in the colored region 54.

The quantity in total of the coloring inks (quantity of the inks ejected per unit volume) may differ with a color to be produced from the inks. In this embodiment, therefore, the clear ink is further used to form the colored region 54 to compensate for color-dependent variation of the quantity in total of the coloring inks. As a result, the colored region 54 favorably colored with the coloring inks may be obtained.

By forming the inner region 52, which serves as a light-reflective region, on the inner side of the colored region 54, light transmitted from the surface of the shaped object 50 through the colored region 54 may be reflected well by the inner region 52, and the shaped object 50 may be favorably colored by the subtractive color mixture. In this embodiment, the shaped object 50 favorably colored may be thus obtained.

To color the shaped object 50 in any desired color, this embodiment further includes color conversion using a device profile adapted for the coloring inks used. The color conversion may be executed at the time of generating the shaping execution data by the host PC 200 (see FIG. 1). The color conversion will be described later in further detail.

The structure of the shaped object 50 described earlier is a non-limiting example. The shaped object 50 may be structured otherwise. For example, the light-reflective region on the inner side of the colored region 54 may be an independent region apart from the inner region 52. In this instance, a light-reflective region is formed on the outer side of the inner region 52 from a light-reflective ink such as a white ink. In case the light-reflective region is thus formed separately from the inner region 52, the inner region 52 may be formed in any color. Therefore, a suitable one of any other inks but the support layer material may be used for the inner region 52. For example, any one of the coloring inks (inks having colors), the clear ink, and a material for exclusive use in shaping may be used to form the inner region 52.

For certain levels of quality that may be required of the shaped object 50, a new region may be formed in addition to the regions described so far. Optionally, a transparent region may be formed from the clear ink (inner clear region) between the inner region 52 (or light-reflective region) and the colored region 54. The inner clear region thus formed may prevent color mixture between the inks of the inner region 52 and of the colored region 54. Optionally, a transparent region may be formed on the outer side of the colored region 54 (surface clear region) to protect the outer surface of the shaped object 50. The surface clear region thus formed may provide adequate protection for the colored region 54.

A further detailed description is given to data processes by the host PC 200 (see FIG. 1) in connection with color conversion using a device profile adapted for the coloring inks. Hereinafter, an operation is described that is carried out to form the shaped object 50 colored on its surface (see FIG. I), as described with reference to FIG. B.

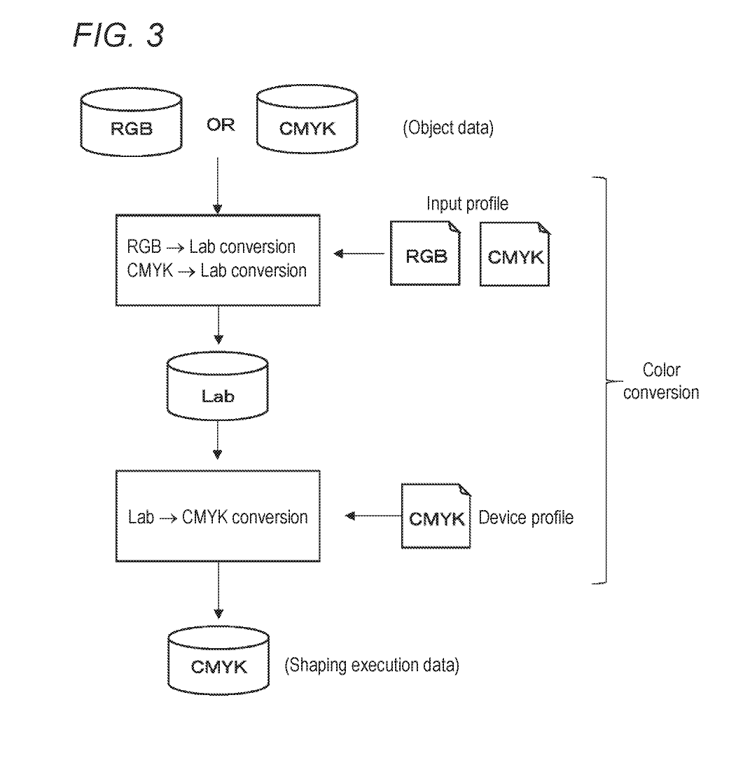

FIG. 3 is a drawing that illustrates processes for color conversion executed by the host PC 200. In this drawing is illustrated the outline of processes associated with color conversion among all of the processes executed by the host PC 200. In this embodiment, as described earlier, the host PC 200 generates the shaping execution data representing the shaped object 50 in a format adapted for the shaping device 100 (see FIG. 1) based on the object data representing the shaped object 50 to be formed. To form the colored shaped object 50 using the shaping device 100, the host PC 200 executes color conversion of the object data representing the shaped object 50 colored at least in part to generate the shaping execution data representing colors expressed in a format adapted for the shaping device 100.

In the object data used before the color conversion, colors are expressed in a format independent of characteristics of the shaping device 100. In the object data, colors may be expressed in an optional color system, for example, RGB color system or CMYK color system.

In this embodiment, the host PC 200 executes color conversion of the colors expressed in the object data into colors of the Lab color system based on an input profile prepared beforehand. The profile described herein refers to data that allows input and output colors to be associated with color space. The input profile used in this embodiment is an ICC profile that associates colors used in the object data with the Lab color space. By using this profile, colors expressed in the RGB color system or CMYK color system in the object data are converted into the Lab colors.

Subsequent to the color conversion to the Lab colors, the host PC 200 executes color conversion in accordance with the coloring inks used in the shaping device 100 using a device profile prepared beforehand adapted for characteristics of the shaping device 100. The device profile used in this embodiment is an ICC profile that associates the Lab color space with colors of the CMYK color space which are the colors of the coloring inks.

The device profile used in this embodiment is an example of the material profile. The material profile is adapted for the plurality of materials having different colors. The profile adapted for the plurality of materials having different colors is a profile for conversion of Lab values in the Lab color space into colors that can be expressed with the plurality of materials having different colors. In this embodiment, the plurality of materials having different colors refer to the C, M, Y, and K coloring inks. In this instance, the device profile may associate the Lab values in the Lab color space with colors that can be expressed with the coloring inks.

In this embodiment, the host PC 200 executes the color conversion using the device profile to generate the shaping execution data that will be supplied to the shaping device 100. The device profile used then for the color conversion has been corrected beforehand in accordance with angles of face inclination in the shaped object 50. The device profile correction in accordance with angles of face inclination will be described later in further detail.

In this embodiment, the shaping execution data adapted for the inks used for shaping may be generated based on the object data through the color conversion using the input profile and the device profile. Thus, the shaped object 50 colored as desired may be favorably obtained by the shaping device 100.

It may be suggested to generate the shaping execution data based on the object data alone, in which case simpler color conversion may be possible, instead of, for example, an ICC profile-used color conversion. In this instance, colors expressed in the RGB color system in the object data may be, as typically done, converted into colors in the CMYK color system according to a conversion equation.

The color conversion thus simplified, however, may entail difficulty in expressing desired colors in the shaped object 50, because a range of colors that can be expressed in the shaped object 50 by a combination of inks (gamut) may be narrower than in two-dimensional printing using the same combination of inks. Therefore, the ICC profile-unused color conversion, which may be simpler, is likely to result in crushed colors. On the other hand, this embodiment may improve the accuracy of color conversion by using the device profile adapted for the inks used. Thus, the shaped object 50 colored as desired may be more favorably obtained by the shaping device 100.

Conventionally, it takes far more time to form the shaped object 50 than to print a two-dimensional image. Therefore, it would be a heavy loss of time to start the production of the shaped object 50 all over again subsequent to failure to express desired colors in this object. In this embodiment, on the other hand, more accurate color conversion is feasible by using the device profile corrected in accordance with angles of face inclination in the shaped object 50 at the time of generating the shaping execution data. This embodiment, therefore, may allow desired colors to be favorably expressed and may accordingly prevent possible do-over due to poor color registration.

The color conversion in this embodiment includes color conversion using the input profile and color conversion using the device profile. The color conversion using the input profile may be referred to as a first color conversion step of converting colors expressed in the object data into Lab values. The color conversion using the device profile may be referred to as a second color conversion step of executing color conversion of the Lab values obtained in the first color conversion step based on the material profile.

The device profile correction in accordance with angles of face inclination in the shaped object 50 is hereinafter described in further detail. As described earlier, this embodiment uses, in the color conversion by the host PC 200, the device profile corrected in accordance with angles of face inclination in the shaped object 50. More specifically, the device profile, which will be used in the color conversion at different positions on the surface of the shaped object 50, is corrected beforehand in accordance with angles of face inclination in the shaped object 50 that are angles through which faces of the shaped object 50 are inclined relative to a preset reference plane.

In this embodiment, the reference plane is a horizontal plane orthogonal to the layer-stacking direction (Z direction). The angle of face inclination at each position may be equal to an angle made by the normal direction of the face at the position with a straight line parallel to the layer-stacking direction.

Hereinafter, the angles of face inclination are discussed in the range of 0° and 90°. While angles equal to and smaller than 90° are used below among all of the angles of face inclination at positions on the surface of the shaped object 50 relative to the horizontal reference plane, the angels of face inclination may be discussed in the range of 0° to 180° for more exact correction of the device profile.

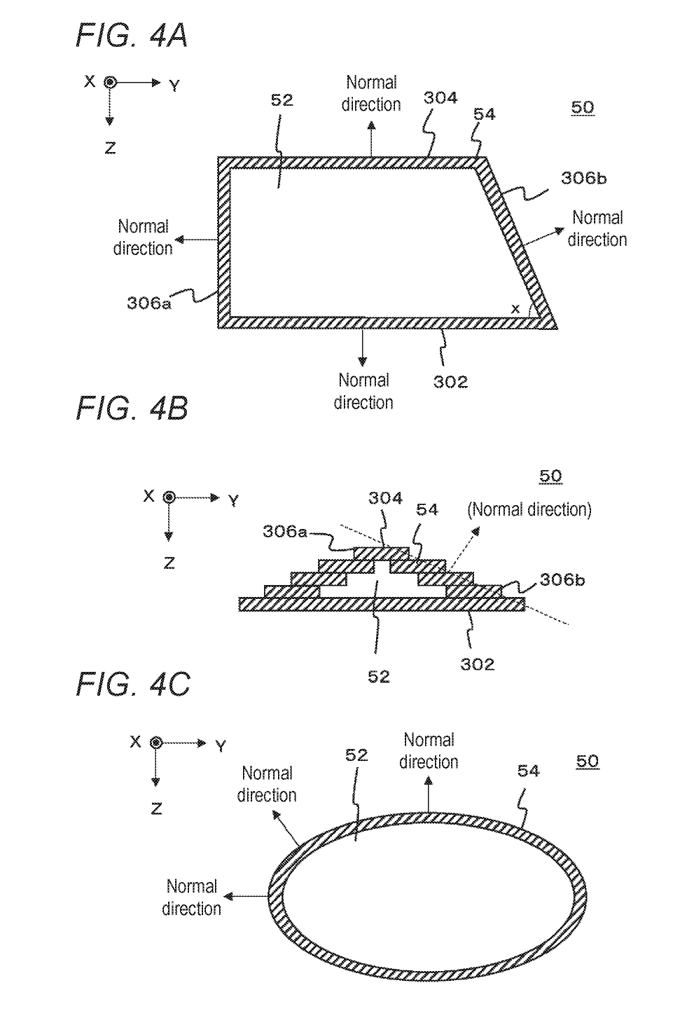

FIGS. 4A to 4C are drawings that illustrate angles of face inclination in the shaped object 50 obtained by the shaping device 100 (see FIG. 1). In these drawings are illustrated angles of face inclination in differently shaped objects 50. FIG. 4A is a drawing that illustrates angles of face inclination in the shaped object 50 shaped as illustrated in FIG. 2B.

As illustrated in these drawings, the surface of the shaped object 50 includes a plurality of flat faces. The surface of the shaped object 50 includes a lower face 302 and an upper face 304, and a plurality of side faces, which are orthogonal to different normal directions. Of the plurality of side faces, FIG. 3A illustrates a side face 306a on one side and a side face 306b on the other side in the main scanning direction (Y direction). In the shaped object 50 thus shaped, angles of face inclination at different positions on the surface of this object are equal to angles of inclination of the faces including the positions.

Referring to FIG. 4A, the lower face 302 and the upper face 304 on the surface of the shaped object 50 are horizontal planes orthogonal to the layer-stacking direction. The side face 306a is a vertical plane orthogonal to the horizontal plane. The side face 306b is an inclined face intersecting the horizontal plane at any angle, “x °”, but the right angle. The angle of face inclination is 0° at positions included in the lower face 302 and the upper face 304. The angle of face inclination is 90° at positions included in the side face 306a. The angle of face inclination is “x °” at positions included in the side face 306b.

In the shaped object 50 thus shaped, a relationship between an angle of observation and an angle of face inclination may differ from one face to another of this object. In the colored region 54 of the shaped object 50, finely structured parts using the coloring inks may appear on the outside differently from one face to another of this object. In case the same device profile is consistently used for the color conversion of all of the object's faces, different color hues may be perceived on the faces inclined through different angles.

As described earlier, this embodiment uses the device profile corrected in accordance with angles of face inclination in the shaped object 50. In this embodiment, therefore, the color conversion may be executed in accordance with different angles of inclination for regions to be colored on the surface of the shaped object 50. This may prevent that different color hues are perceived on the faces of the shaped object 50 that are inclined through different angles, and may thereby ensure a high quality of the object formed.

The shaping device 100 may possibly be used to form a shaped object 50 with small differences in level on its surface, in contrast to the object shaped as illustrated in FIG. 4A. As an example of such an object with small differences in level on its surface, FIG. 4B illustrates a pyramidal shaped object 50.

As illustrated in the drawing, side faces 306a and 306b of this shaped object 50 constitute a surface with steps. In the shaped object 50 thus shaped, the side faces 306a and 306b may present different color hues, unlike the flat faces of the shaped object 50 illustrated in FIG. 4A. The shaped object 50 of FIG. 4B, when observed slantwise, for example, may be variable in color hue at different positions because the colored region 54 is not uniform in thickness in the direction of observation.

As described earlier, this embodiment corrects the device profile in accordance with angles of face inclination in the shaped object 50 for respective positions on the surface of this object. Therefore, the shaped object 50 with small differences in level on its surface may be colored at positions on the surface in desired colors.

As illustrated in the drawing, the side faces 306a and 306b are respectively a horizontal plane and a vertical plane that are formed one after the other. In this instance, the device profile may be corrected in different manners for the horizontal planes and for the vertical planes.

For certain levels of quality that may be required of the shaped object 50, adequately accurate coloring may be possible at some positions on the side faces 306a and 306b without changing the manner of correcting the device profile. In that case, the device profile may be corrected based on the assumption that the side faces 306a and 306b constitute a planar surface. As illustrated in the drawing with a broken line at positions on the side faces 306b, the device profile may possibly be corrected based on planes along the side faces 306b and the normal directions of these planes.

The shaping device 100 may form the shaped object 50 having a curved surface at least in part. As an example of such an object having a curved surface at least in part, FIG. 4C illustrates an elliptical shaped object 50.

In the shaped object 50 with such a curved surface, angles of face inclination may continue to change from one position to another. The angle of face inclination means an angle of inclination of a plane orthogonal to the normal direction at each position. Likewise, such an object may be colored in desired colors at different positions on its surface by correcting the device profile in accordance with the angles of face inclination at the positions.

In this embodiment, the positions on the surface of the shaped object 50 may each refer to the position of a voxel (three-dimensional pixel), among voxels set for a required resolution. For certain levels of accuracy that may be required to color the object, each position on the surface of the shaped object 50 may correspond to, instead of one voxel, a plurality of voxels included within a defined region.

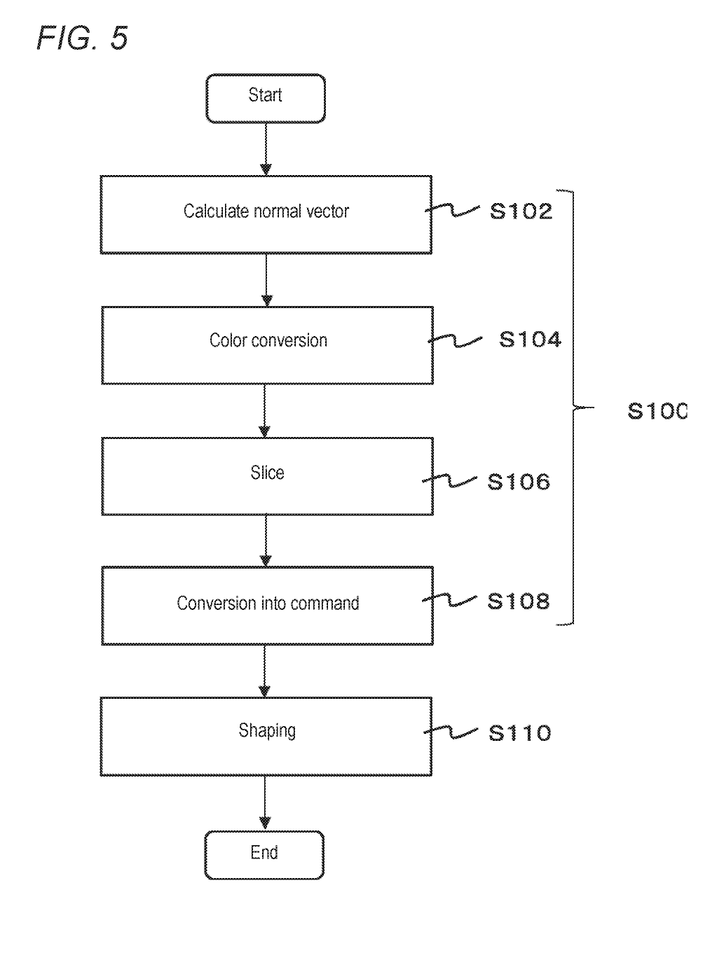

The shaping operation of the shaping system 10 is hereinafter described in further detail. FIG. 5 is a flow chart of the operation carried out by the shaping system 10. To form the shaped object 50 colored on its surface, the shaping system 10 in this embodiment, first, prompts the host PC 200 to generate the shaping execution data based on the object data (S100). Step S100 is an example of the data generating step. In Step S100, the host PC 200 executes the processes for color conversion described earlier.

In Step S100, the host PC 200 calculates normal vectors with respect to faces of the shaped object 50 to be formed (S102). In this step, the host PC 200 calculates reversed normal vectors with respect to faces of a 3D model represented by the object data. In this instance, the faces of the 3D model refer to outer peripheral faces of the 3D model. Calculating the reversed normal vectors respect to the faces may be rephrased as calculating reversed normal vectors orthogonal to the outer peripheral faces at positions on the outer peripheral faces of the 3D model. The reversed normal vector described herein refers to a vector orthogonal to each outer peripheral face of the 3D model and directed toward the inner side of the 3D model (reversed plane normal vector).

After the reversed normal vectors are calculated, the host PC 200 executes the processes for color conversion described referring to FIG. 3. For example, the host PC 200 may execute color conversion of the RUB colors or CMYK colors set in the object data into the Lab colors based on the input profile. The host PC 200 may further execute color conversion of the obtained Lab colors into the CMYK colors based on the device profile.

In this embodiment, the host PC 200 uses, in the color conversion, the device profile corrected in accordance with angles of face inclination in the shaped object 50. The host PC 200 may calculate the angles of face inclination at positions on the surface of the shaped object 50 based on the reversed normal vectors calculated in Step S102. For positions in a region to be colored on the surface of the shaped object 50, the host PC 200 executes the color conversion using the device profile corrected in accordance with angles of face inclination at the positions. During the process in Step S104, for example, the host PC 200 sets the regions of the shaped object 50 (inner region and colored region) in the 3D model representing the shaped object 50.

Subsequent to the color conversion in Step S104, the host PC 200 generates sliced images based on the processed 3D model (S106). Generating the sliced images may be rephrased as generating sliced data, which is the 3D model divided at certain intervals into round slices. The sliced image may be an image expressed by an ink layer generated correspondingly to a piece of sliced data. Specifically, the host PC 200 generates the sliced images by dividing the 3D model into slices at intervals each equal to the thickness of an ink layer formed by the shaping device 100 (ink thickness for each layer). Thus, the sliced images representing cross sections at different positions in the layer-stacking direction are generated based on the object data.

After the sliced images are generated, the host PC 200 converts the 3D model into commands based on the sliced images (S108). Converting the 3D model into commands may be rephrased as converting data of the 3D model into a format that can be processed by the shaping device 100. The 3D model is converted into data, for each of the sliced images, in a format that allows the shaping device 100 to form the shaped object 50. The host PC 200 generates the shaping execution data representing the shaped object 50 in a format adapted for the shaping device 100.

In data obtained from the sliced images after the command conversion, the inks used to form the shaped object 50 by the shaping device 100 are designated to pixels. The sliced images after the command conversion constitute the shaping execution data.

Subsequent to Step S108, the host PC 200 feeds the shaping device 100 with the generated shaping execution data. The shaping device 100 carries out the operation to form the shaped object (forms and stacks ink layers) based on the received shaping execution data (S110). In this embodiment, Step S110 is an example of the shaping step, in which the shaped object 50 is formed based on the shaping execution data. In Step S110, the shaping device 100 forms the shaped object 50 using the layer stacking method, specifically, ejects the materials for shaping based on the shaping execution data received from the host PC 200 to form each one of multiple ink layers constituting the shaped object 50. According to this embodiment, the shaped object 50 colored on its surface may be favorably formed.

In Step S106 of generating the sliced images and all of the steps before Step S106 in the flow chart, data in a standard format independent of characteristics of the shaping device 100 may possibly be used. In Step 108 of the command conversion and subsequent steps, data in a format adapted for the shaping device 100 may be used. In the description given so far, the host PC 200 is in charge of Step S100, while the shaping device 100 is in charge of Step S110. In a modified example of the shaping system 10, the shaping device 100 may also be in charge of a part or the whole of Step S100.

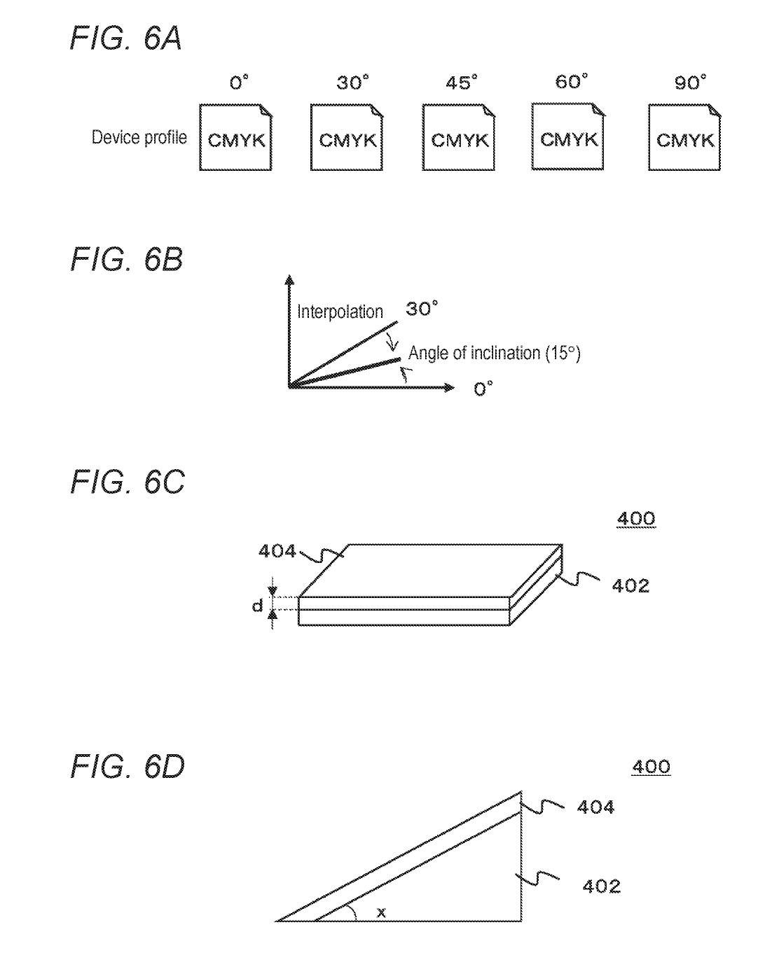

The device profile correction in this embodiment is described below in further detail, FIGS. 6A to 6D are drawings that specifically illustrate the device profile correction. FIGS. 6A and 6B are schematic drawings that illustrate examples of the device profile correction.

As illustrated in FIG. 6A, the device profile correction in this embodiment uses a plurality of device profiles created beforehand correspondingly to different angles of face inclination (angle-specific profiles). The illustrated example uses a plurality of device profiles created correspondingly to angles of 0°, 30°, 45°, 60° and 90°. These device profiles may be prepared beforehand based on, for example, values actually measured using a color measuring chart.

The color conversion for a respective one of positions on the surface of the shaped object 50 includes an interpolating process based on these device profiles to correct the device profiles in accordance with the angle of face inclination at the position. First, the angle of face inclination at each position on the surface of the shaped object 50 is obtained based on the object data representing the shaped object 50 to be formed. As illustrated in FIG. 6B, the interpolating process is then executed, in which the following values are used; a value in the device profile associated with an angle of face inclination smaller than the obtained angle of face inclination (first device profile), and a value in the device profile associated with an angle of face inclination greater than the obtained angle of face inclination (second device profile). FIG. 6B schematically illustrates an example of the interpolating process for the shaped object 50 having faces inclined through 15°. This interpolating process uses the device profile with 0° and the device profile with 30°. This interpolating process may allow the device profiles to be corrected in accordance with the angles of face inclination at different positions in the shaped object 50. In any shaped objects 50 with faces inclined through different angles, therefore, desired colors may be successfully expressed with colors calculated in the color conversion.

When an angle of face inclination in the shaped object 50 is equal to the angle of face inclination in any one of the angle-specific profiles, a value in the device profile corresponding to the angle of face inclination in the shaped object 50 may be obtained without such an interpolating process. In that case, selecting one of the angle-specific profiles associated with an angle equal to the angle of face inclination in the shaped object 50 may be considered an operation to correct the device profiles. The interpolating process described above may possibly be skipped for a particular angle(s) of face inclination. Yet, it is regarded in such a case as well that the device profiles are corrected in accordance with the angle of face inclination.

The interpolating process accompanying the device profile correction may include an interpolating process for chromaticity values or ink quantities used to express designated colors. The interpolating process may further include an interpolating process for correction values used in the color conversion. The interpolating process accompanying the device profile correction may be, for example, linear interpolation. This may facilitate and improve the interpolating process. For certain levels of quality that may be required of the object, the interpolating process may be, for example, non-linear interpolation.

So far was described the device profile correction for the angles of faces in the shaped object 50 that are inclined in the Z direction relative to the reference horizontal plane. In a modified example of the shaping device 100, the device profile correction in accordance with angles of face inclination may be possible with any objects having faces inclined relative to any reference plane but the horizontal plane.

In this embodiment, the device profiles, which are angle-specific profiles, are created beforehand based on the actually measured values using the color measuring chart. FIGS. 6C and 6D are drawings of charts 400 used in color measuring (3D color measuring) to create the angle-specific profiles. FIG. 6C is a drawing of a chart 400 with an angle of inclination, 0°. FIG. 6d is a drawing of a chart 400 with any angle, “x °”, but 0°.

For color measuring to create the angle-specific profiles, a plurality of charts 400 may be drawn that respectively include faces inclined through different angles to measure color hues on these charts 400 using, for example, a colorimeter. An example of the chart 400 may be a chart including a base part 402 and a colored part 404, as illustrated in the drawing.

The base part 402 is a light-reflective region formed from, for example, a white ink. The base part 402 may be thick enough to adequately reflect light (for example, thickness of 100 μm or more, or 300 μm or more). The colored part 404 is a colored region similar to the colored region of the shaped object 50. The colored part 404 is formed on the surface side of the chart 400 in a color-measurable manner. The colored part 404 may have a similar thickness to the colored region of the shaped object 50. Specifically, the colored part 404 has a thickness “d” of approximately 300 μm (for example, thickness of approximately 100 to 500 μm, or approximately 200 to 400 μm). The thicknesses of the base part 402 and the colored part 404 are thicknesses of parts in the chart 400 subjected to color measuring.

In the chart 400 with 0°, the base part 402 and the colored part 404 may he formed on, for example, a horizontal surface in a uniform thickness and in parallel to the surface, as illustrated in FIG. 6C. The thickness of the colored part 404 may be approximately 300 μm. In the chart 400 with any angle, “x °”, but 0°, the base part 402 may be formed with an incline, and the colored part 404 may be formed in a similar thickness to the thickness in the chart with 0°, as illustrated in FIG. 6D. In this manner, the charts 400 may be created correspondingly to variously different angles.

The process to create the angle-specific profiles includes a color measuring process for a respective one of the charts 400 and subsequent profiling for different angles in these charts. The color measuring is performed at positions on normal vectors on surfaces of the charts 400 by using, for example, a conventional colorimeter. In this manner, the color measuring for each chart 400 may be performed under the conditions similar to, for example, conditions when a picture drawn on the surface of the shaped object 50 is looked at from the front side. The color measuring may be performed in a manner identical or similar to color measuring in two-dimensional image printing. Thus, the color measuring may be easily and suitably feasible.

In this instance, the color measuring is performed for the charts 400 to create a profile corresponding to the angle in each chart 400 (for example, ICC profile). For the charts with any angles but 0°, correction values are calculated to enable the same color hue as the angle of 0° to create the angle-specific profiles. Thus, the angle-specific profiles may be created based on measured values of color hues on inclined faces colored with different coloring inks used for the shaped object 50. By using the angle-specific profiles in the color conversion by the host PC 200, the device profile correction is feasible in accordance with the angle of face inclination in the shaped object 50.

Thus, the purpose of the color measuring using the charts 400 is to create the angle-specific profiles. The color measuring, therefore, may be only required before the shipment of the shaping device 100 or to review the method of correction. To further facilitate the color measuring using the charts 400, one chart 400 may be used and inclined through different angles to measure different color hues. For example, the chart 400 with 0° may be created and inclined through different angles, which may allow the angle-specific profiles to be created in a more simplified manner.

### INDUSTRIAL APPLICABILITY

This disclosure may be applicable to a shaping method.

What is claimed is:

1. A shaping method for shaping an object having a surface colored at least in part, the shaping method comprising:
a data generating step of generating shaping execution data representing the object in a format adapted for a shaping device that carries out an operation to shape the object; and
a shaping step of shaping the object based on the shaping execution data using the shaping device and at least a plurality of materials having different colors for shaping,
the data generating step further comprising:
executing at least color conversion based on object data representing the object using a material profile adapted for the plurality of materials having different colors to generate the shaping execution data; and
using, in the color conversion executed at a respective one of positions on the surface of the object, the material profile corrected in accordance with an angle of face inclination through which a face of the object is inclined relative to a preset reference plane.

2. The shaping method according to claim 1, wherein, in the data generating step,
a plurality of the material profiles are used that are created beforehand correspondingly to the angles of face inclination that differ from each other, and
the plurality of the material profiles are each created by measuring beforehand a color hue on an inclined face assumed to be formed by using the plurality of materials having different colors.

3. The shaping method according to claim 1, wherein, in the data generating step,
a plurality of the material profiles are used that are created beforehand correspondingly to the angles of face inclination that differ from each other,
the angle of face inclination on the surface of the object to be formed is obtained based on the object data,
an interpolating process is executed by using a value in a first one of the plurality of the material profiles associated with the angle of face inclination smaller than the angle of face inclination obtained and a value in a second one of the plurality of the material profiles associated with the angle of face inclination greater than the angle of face inclination obtained so that the material profile is corrected in accordance with the angle of face inclination of the face of the object.

4. The shaping method according to claim 1, wherein, in the data generating step, the color conversion is executed by using the material profile corrected in accordance with the angle of face inclination at a respective one of positions in a region to be colored on the surface of the object.

5. The shaping method according to claim 1, wherein the material profile is a profile for conversion of a Lab value into a color that can be expressed with the plurality of materials having different colors.

6. A shaping system configured to shape a three-dimensional object, the shaping system comprising:
a shaping device that carries out an operation to shape the object; and
a data generating device that generates shaping execution data representing the three-dimensional object in a format adapted for shaping device,
the shaping device forming the three-dimensional object based on the shaping execution data using at least a plurality of materials having different colors for shaping,
the data generating device executing at least color conversion based on object data representing the three-dimensional object using a material profile adapted for the plurality of materials having different colors to generate the shaping execution data,
the data generating device using, in the color conversion executed at a respective one of positions on the surface of the three-dimensional object, the material profile corrected in accordance with an angle of face inclination through which a face of the three-dimensional object is inclined relative to a preset reference plane.

7. A shaping device configured to shape a three dimensional object, the shaping device forming the three-dimensional object using at least a plurality of materials having different colors for shaping based on shaping execution data generated by and received from a data generating device, the shaping execution data being data representing the three dimensional object in a format adapted for the shaping device:
the data generating device executing at least color conversion based on object data representing the three-dimensional object using a material profile adapted for the plurality of materials having different colors to generate the shaping execution data,
the data generating device using, in the color conversion executed at a respective one of positions on the surface of the three-dimensional object, the material profile corrected in accordance with an angle of face inclination through which a face of the three-dimensional object is inclined relative to a preset reference plane.

8. The shaping method according to claim 2, wherein, in the data generating step,
a plurality of the material profiles are used that are created beforehand correspondingly to the angles of face inclination that differ from each other,
the angle of face inclination on the surface of the object to be formed is obtained based on the object data,
an interpolating process is executed by using a value in a first one of the plurality of the material profiles associated with the angle of face inclination smaller than the angle of face inclination obtained and a value in a second one of the plurality of the material profiles associated with the angle of face inclination greater than the angle of face inclination obtained so that the material profile is corrected in accordance with the angle of face inclination of the face of the object.

9. The shaping method according to claim 2, wherein, in the data generating step, the color conversion is executed by using the material profile corrected in accordance with the angle of face inclination at a respective one of positions in a region to be colored on the surface of the object.

10. The shaping method according to claim 3, wherein, in the data generating step, the color conversion is executed by using the material profile corrected in accordance with the angle of face inclination at a respective one of positions in a region to be colored on the surface of the object.

11. The shaping method according to claim 8, wherein, in the data generating step, the color conversion is executed by using the material profile corrected in accordance with the angle of face inclination at a respective one of positions in a region to be colored on the surface of the object.

12. The shaping method according to claim 2, wherein the material profile is a profile for conversion of a Lab value into a color that can be expressed with the plurality of materials having different colors.

13. The shaping method according to claim 3, wherein the material profile is a profile for conversion of a Lab value into a color that can be expressed with the plurality of materials having different colors.

14. The shaping method according to claim 4, wherein the material profile is a profile for conversion of a Lab value into a color that can be expressed with the plurality of materials having different colors.

15. The shaping method according to claim 8, wherein the material profile is a profile for conversion of a Lab value into a color that can be expressed with the plurality of materials having different colors.

16. The shaping method according to claim 9, wherein the material profile is a profile for conversion of a Lab value into a color that can be expressed with the plurality of materials having different colors.

17. The shaping method according to claim 10, wherein the material profile is a profile for conversion of a Lab value into a color that can be expressed with the plurality of materials having different colors.

18. The shaping method according to claim 11, wherein the material profile is a profile for conversion of a Lab value into a color that can be expressed with the plurality of materials having different colors.
